(19) United States
(12) Patent Application Publication
(10) Pub. No.: US 2018/0249121 A1
(43) Pub. Date: Aug. 30, 2018

(54) FRAME GENERATION APPARATUS, FRAME GENERATION METHOD, SIGNAL EXTRACTION APPARATUS, SIGNAL EXTRACTION METHOD, AND IMAGE TRANSMISSION SYSTEM

(71) Applicant: SONY CORPORATION, TOKYO (JP)

(72) Inventors: TOSHIHISA HYAKUDAI, KANAGAWA (JP); KAZUAKI TOBA, KANAGAWA (JP)

(21) Appl. No.: 15/773,034

(22) PCT Filed: Aug. 4, 2016
(86) PCT No.: PCT/JP2016/072918

§ 371 Date: May 2, 2018

(30) Foreign Application Priority Data
Nov. 17, 2015 (JP) 2015-224596

(51) Int. Cl. H04N 7/10; H04N 7/08; H04N 5/44

(52) U.S. Cl. CPC H04N 7/104; H04N 5/44; H04N 7/08

(57) ABSTRACT

[Object] It is desired to provide a technology in which a video audio signal and a control signal can be transmitted via a connector even if the vertical direction of the connector is reversed.

[Solution] Provided is a frame generation apparatus including: a first frame generation section configured to generate one or more video audio frames from a video audio signal by a format having a prescribed data capacity as a frame unit; and a second frame generation section configured to generate one or more control frames from a control signal by a format having the same data capacity as the prescribed data capacity as a frame unit.

### TECHNICAL FIELD

The present disclosure relates to a frame generation apparatus, a frame generation method, a signal extraction apparatus, a signal extraction method, and an image transmission system.

BACKGROUND ART

These days, High-Definition Multimedia Interface (HDMI) and DisplayPort are standardized as standards of video image transmission between devices, and are commonly used.

In HDMI, a source device and a sink device are connected together via an HDMI cable.

The HDMI cable transmits a Transition-Minimized Differential Signaling (TMDS) signal from the source device to the sink device. Further, the HDMI cable transmits Display Data Channel (DDC) and Consumer Electronics Control (CEC), which are two kinds of bidirectional control signals. Furthermore, the HDMI cable transmits a +5V signal and a Hot Plug Detect (HPD) signal for detecting device connection.

The TMDS signal includes a total of 4 channels, i.e., 3 channels that transmit a video audio signal and a channel that transmits a video clock. Further, DDC has the same format as I2C and is a control signal of Extended Display Identification Data (EDID) information or the like, and CEC is a 1-channel, bidirectional inter-device operation control signal. That is, the video audio signal and the control signals are transferred by different formats.

Thus, in an HDMI device, since the video audio signal and the control signals are transmitted by different formats, signal processing circuits corresponding to all the video audio signal and the control signals are needed. Hence, in the connection between the source device and the sink device, there is a limitation on the vertical direction of a connector and a structure that does not allow the reversion of the vertical direction (hereinafter, occasionally referred to as “reverse insertion”) is employed so that the video audio signal and the control signals are supplied to the respective corresponding signal processing circuits.

Further, a technology in which a video audio signal that is a high-speed signal and a control signal that is a low-speed signal are separated and these signals are optically transmitted in a separate manner is disclosed (for example, see Patent Literature 1).

### CITATION LIST

### Patent Literature

Patent Literature 1: JP 2005-65034A

### DISCLOSURE OF INVENTION

### Technical Problem

However, also in such a technology, a user needs to connect a connector to a device while checking that the vertical direction of the connector is correct, and hence the user has been inconvenienced. Thus, it is desired to provide a technology in which a video audio signal and a control signal can be transmitted via a connector even if the vertical direction of the connector is reversed.

### Solution to Problem

According to the present disclosure, there is provided a frame generation apparatus including: a first frame generation section configured to generate one or more video audio frames from a video audio signal by a format having a prescribed data capacity as a frame unit; and a second frame generation section configured to generate one or more control frames from a control signal by a format having the same data capacity as the prescribed data capacity as a frame unit.

According to the present disclosure, there is provided a frame generation method including: generating one or more video audio frames from a video audio signal by a format having a prescribed data capacity as a frame unit; and generating one or more control frames from a control signal by a format having the same data capacity as the prescribed data capacity as a frame unit.

According to the present disclosure, there is provided a signal extraction apparatus including: a first signal extraction section configured to extract a first signal from one or more first frames having a prescribed data capacity as a frame unit; and a second signal extraction section configured to extract a second signal from one or more second frames having the same data capacity as the prescribed data capacity as a frame unit. Of a video audio signal and a control signal, one is the first signal and another is the second signal.

According to the present disclosure, there is provided a signal extraction method including: extracting a first signal from one or more first frames having a prescribed data capacity as a frame unit; and extracting a second signal from one or more second frames having the same data capacity as the prescribed data capacity as a frame unit. Of a video audio signal and a control signal, one is the first signal and another is the second signal.

According to the present disclosure, there is provided an image transmission system including: a transmitter including a first frame generation section configured to generate one or more video audio frames from a video audio signal by a format having a prescribed data capacity as a frame unit, a second frame generation section configured to generate one or more control frames from a control signal by a format having the same data capacity as the prescribed data capacity as a frame unit, a first transmission section configured to transmit the video audio frame, and a second transmission section configured to transmit the control frame; and a receiver including a first reception section configured to receive one or more first frames having the prescribed data capacity as a frame unit, a second reception section configured to receive one or more second frames having the same data capacity as the prescribed data capacity as a frame unit, a first signal extraction section configured to extract a first signal from the first frame, and a second signal extraction section configured to extract a second signal from the second frame. Of the video audio signal and the control signal, one is the first signal and another is the second signal.

### Advantageous Effects of Invention

As described above, according to the present disclosure, a technology in which a video audio signal and a control signal can be transmitted via a connector even if the vertical direction of the connector is reversed is provided. Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 a diagram showing connection of a plurality of ordinary HDMI devices.

FIG. 2 is a diagram showing an example of pin assignment of a connector of an ordinary HDMI device.

FIG. 3 is a diagram showing an example of a configuration of an image transmission system according to an embodiment of the present disclosure.

FIG. 4 is a diagram showing an example of a functional configuration of a frame generation section.

FIG. 5 is a diagram showing a format of a frame according to the present embodiment.

FIG. 6 is a diagram showing an example of a functional configuration of a signal extraction section.

FIG. 7 is a diagram showing another example of a configuration of an image transmission system according to the embodiment.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Further, in the present specification and the drawings, a plurality of components having substantially the same functional configuration are distinguished by marking different numerals after the same reference character. However, in a case where it is not necessary to particularly distinguish each of a plurality of components having substantially the same functional configuration and the like, they are marked with only the same reference character. Further, like components of different embodiments are distinguished by marking different alphabet letters after the same reference character.

Note that the description is given in the following order.
1. Background
2. Configurational example of image transmission system
2.1. Case where vertical direction of connector is correct
2.2. Case where vertical direction of connector is reverse
3. Conclusions

### <1. Background>

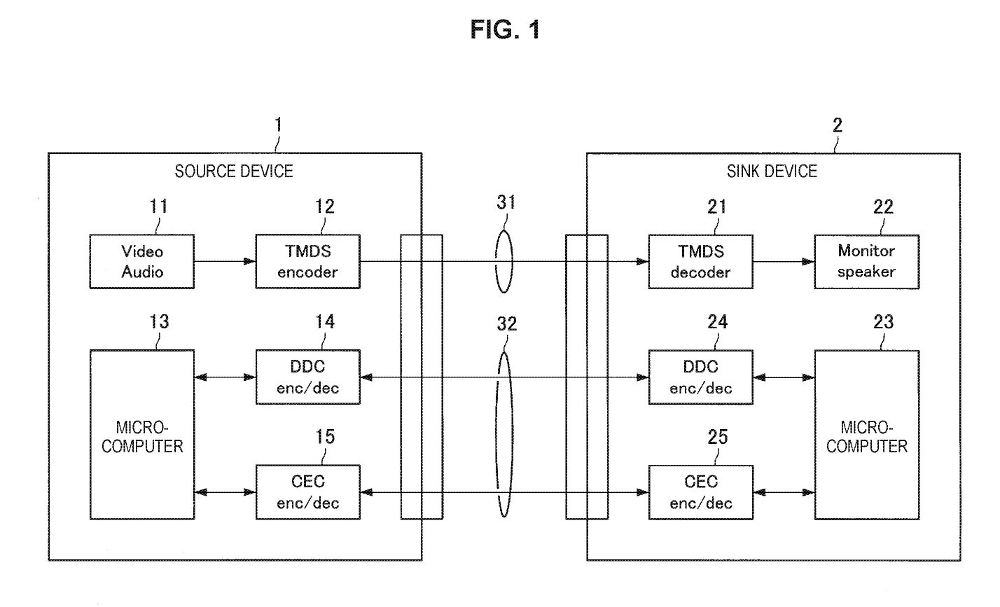

First, the background of the present embodiment is described. These days, HDMI and DisplayPort are standardized as standards of video image transmission between devices, and are commonly used. FIG. 1 is a diagram showing the connection of a plurality of ordinary HDMI devices. As shown in FIG. 1, a source device 1 and a sink device 2 are connected together via an HDMI cable (a channel group 31 and a line group 32).

The source device 1 generates a video audio signal (Video Audio 11), performs TMDS encoding on the generated video audio signal with a TMDS encoder 12, and transmits the TMDS-encoded video audio signal. The channel group 31 transmits a TMDS signal from the source device 1 to the sink device 2. Further, the sink device 2 receives the TMDS-encoded video audio signal, decodes the received video audio signal with a TMDS decoder 21, and reproduces the decoded video audio signal with a monitor speaker 22.

Further, the line group 32 transmits DDC and CEC, which are two kinds of bidirectional control signals. Specifically, if DDC is inputted to a DDC enc/dec 14 from a microcomputer 13 in the source device 1, the DDC is encoded by the DDC enc/dec 14, and is transmitted. The line group 32 transmits the DDC from the source device 1 to the sink device 2. In the sink device 2, the DDC is decoded by a DDC enc/dec 24, and is outputted to a microcomputer 23.

On the other hand, if DDC is inputted to the DDC enc/dec 24 from the microcomputer 23 in the sink device 2, the DDC is encoded by the DDC enc/dec 24, and is transmitted. The line group 32 transmits the DDC from the sink device 2 to the source device 1. In the source device 1, the DDC is decoded by the DDC enc/dec 14, and is outputted to the microcomputer 13.

Further, if CEC is inputted to a CEC enc/dec 15 from the microcomputer 13 in the source device 1, the CEC is encoded by the CEC enc/dec 15, and is transmitted. The line group 32 transmits the CEC from the source device 1 to the sink device 2. In the sink device 2, the CEC is decoded by a CEC enc/dec 25, and is outputted to the microcomputer 23.

On the other hand, if CEC is inputted to the CEC enc/dec 25 from the microcomputer 23 in the sink device 2, the CEC is encoded by the CEC enc/dec 25, and is transmitted. The line group 32 transmits the CEC from the sink device 2 to the source device 1. In the source device 1, the CEC is decoded by the CEC enc/dec 15, and is outputted to the microcomputer 13.

The TMDS signal includes a total of 4 channels, i.e., 3 channels that transmit a video audio signal and a channel that transmits a video clock. Further, DDC has the same format as I2C and is a control signal of Extended Display Identification Data (EDID) information or the like, and CEC is a 1-channel, bidirectional inter-device operation control signal. That is, the video audio signal and the control signals are transferred by different formats.

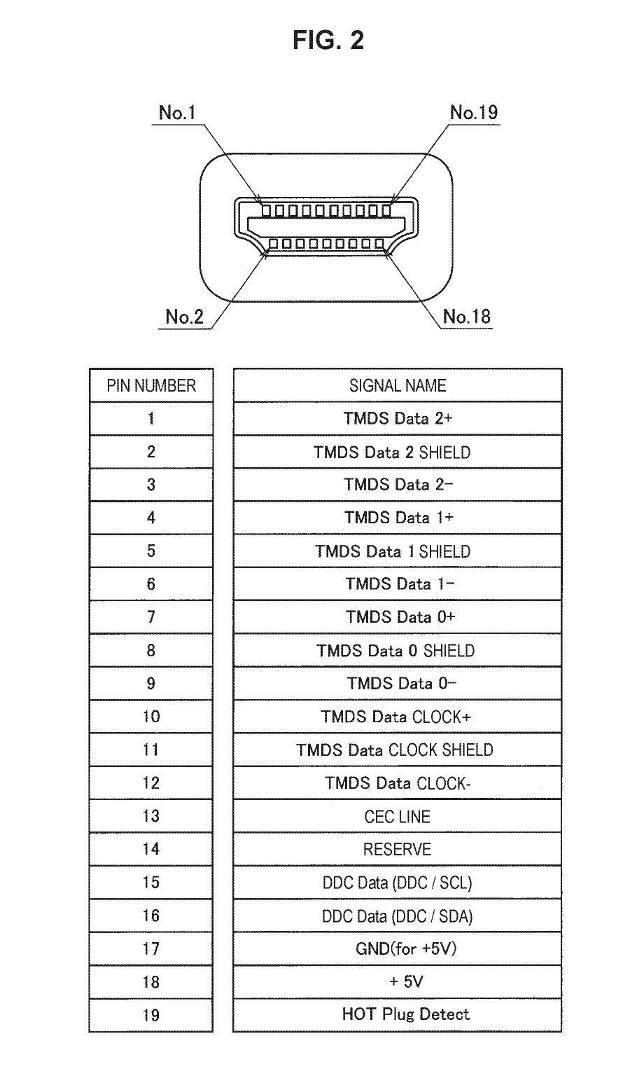

FIG. 2 is a diagram showing an example of the pin assignment of a connector of an ordinary HDMI device. As shown in FIG. 2, pins from pin number “1” to pin number “19” are provided in the connector of the HDMI device. For example, a TMDS signal is communicated via the pins from pin number “1” to pin number “12,” CEC is communicated via the pin of pin number “13,” and DDC is communicated via the pins from pin number “15” to pin number “16.”

In such an HDMI device, since the video audio signal and the control signals are transmitted by different formats, signal processing circuits corresponding to all the video audio signal and the control signals are needed. Hence, as shown in FIG. 2, in the connection of the source device 1 and the sink device 2, there is a limitation on the vertical direction of the connector and a structure that does not allow reverse insertion is employed so that the video audio signal and the control signals are supplied to the respective corresponding signal processing circuits.

Further, a technology in which a video audio signal that is a high-speed signal and a control signal that is a low-speed signal are separated and these signals are optically transmitted in a separate manner is disclosed (for example, JP 2005-65034A). Also in such a technology, a user needs to connect a connector to a device while checking that the vertical direction of the connector is correct, and hence the user is inconvenienced.

Further, in a case where the source device 1 and the sink device 2 are optically connected together, if remains such as dust enter the connector at the time of connecting the devices, there is a case where the transmission quality in the optical transmission path is degraded by the inhibition of transmission due to the remains, and information cannot be transmitted correctly via the optical transmission path. In particular, in a case where a control signal is not transmitted correctly, the control between devices etc. cannot be performed correctly; thus, the influence given to the device is larger than in a case where information of a video audio signal cannot be transmitted correctly.

Thus, the present specification proposes a technology in which a video audio signal and a control signal can be transmitted via a connector even if the vertical direction of the connector is reversed. Further, the present specification proposes a technology in which the possibility that a control signal, which is required to have higher reliability (a lower error rate) than a video audio signal, is transmitted correctly can enhanced.

Hereinabove, the background of the present embodiment is described.

### [2. Configurational Example of Image Transmission System]

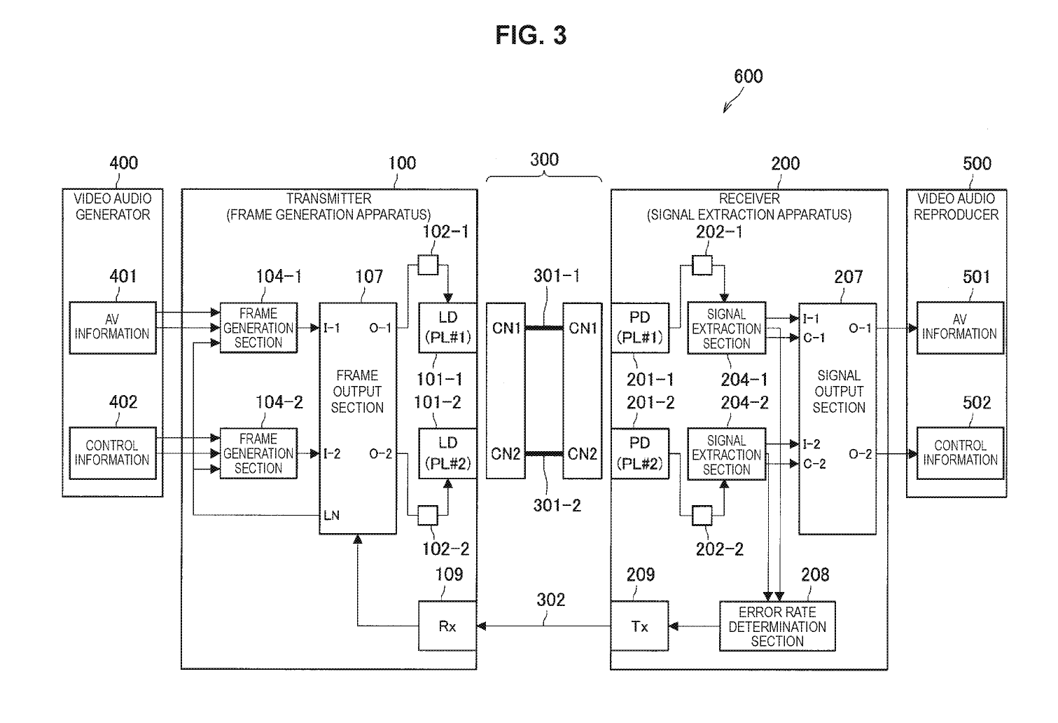

Next, a configurational example of an image transmission system is described with reference to FIG. 3. FIG. 3 is a diagram showing an example of the configuration of an image transmission system according to the present embodiment. As shown in FIG. 3, an image transmission system 600 includes a video audio generator 400, a transmitter 100, a receiver 200, and a video audio reproducer 500. The transmitter 100 and the receiver 200 are connected together via a cable 300. Although in the present embodiment an example in which a transmission path 301-1 (a first transmission path) and a transmission path 301-2 (a second transmission path) are included in the cable 300 is described, the number of transmission paths 301 is not particularly limited as long as it is plural.

### (2.1. Case Where Vertical Direction of Connector is Correct)

In the example shown in FIG. 3, a laser diode (LD) 101-1 of the transmitter 100 and a connector CN1 of the cable 300 are connected together, and a photodetector (PD) 201-1 of the receiver 200 and a connector CN1 of the cable 300 are connected together. Further, an LD 101-2 of the transmitter 100 and a connector CN2 of the cable 300 are connected together, and a PD 201-2 of the receiver 200 and a connector CN2 of the cable 300 are connected together. Such a state is a state where the vertical direction of the connector is correct. Note that the transmitter 100 can function as a “frame generation apparatus.” Further, the receiver 200 can function as a “signal extraction apparatus.”

The video audio generator 400 generates a video audio signal (audio video information (AV information) 401), outputs the generated video audio signal as an information packet to the transmitter 100, and outputs information corresponding to the video audio signal (e.g., “1”) as an information type identifier to the transmitter 100. Further, the video audio generator 400 generates a control signal (control information 402), outputs the generated control signal as an information packet to the transmitter 100, and outputs information corresponding to the control signal (e.g., “0”) as an information type identifier to the transmitter 100.

Note that the control signal according to the present embodiment includes various control signals such as a signal for controlling the reproduction of a video audio signal and a device control signal. Further, in the present embodiment, the data rate of the video audio signal and the data rate of the control signal yielded by the video audio generator 400 are smaller than a frame transmission capacity that can be transmitted by the transmitter 100 and a frame reception capacity that can be received by the receiver 200.

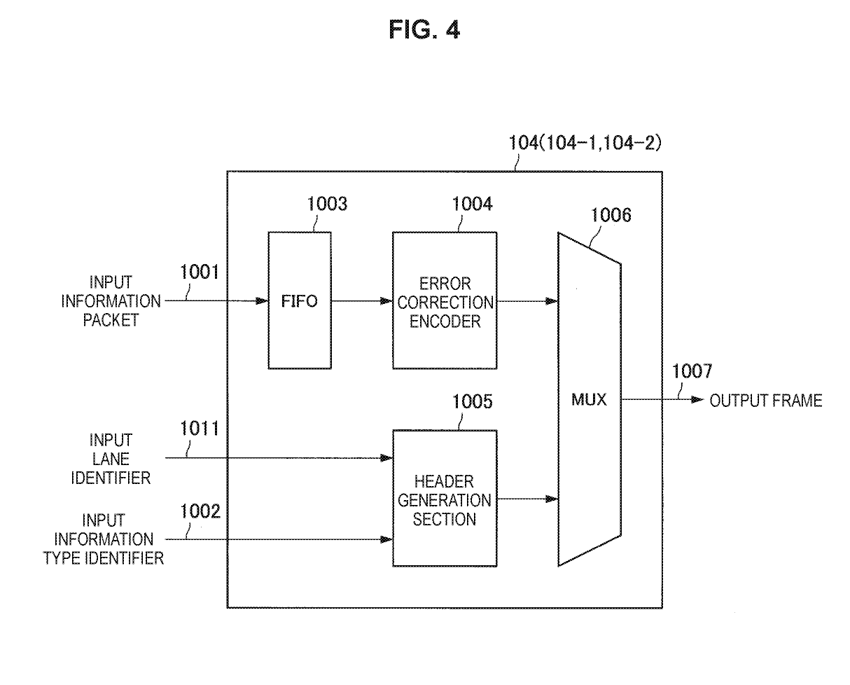

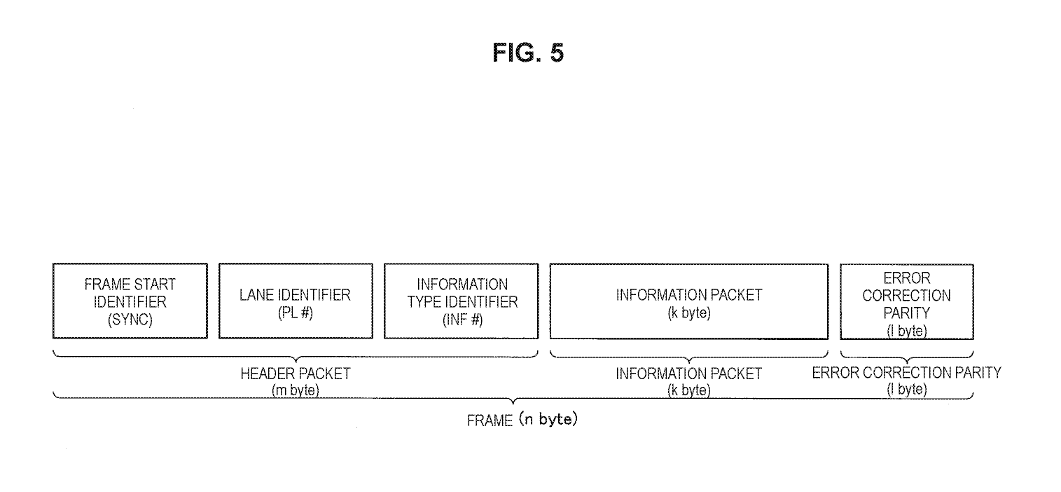

The transmitter 100 includes a frame generation section 104-1 (a first frame generation section), a frame generation section 104-2 (a second frame generation section), a frame output section 107, a laser diode driver (LDD) 102-1, an LDD 102-1, the LD 101-1, the LD 101-2, and a reception section 109. A video audio signal is inputted to the frame generation section 104-1, and a control signal is inputted to the frame generation section 104-2. FIG. 4 is a diagram showing an example of the functional configuration of a frame generation section 104. Referring to FIG. 4, the example of the functional configurational of the frame generation section 104 is shown without distinguishing the frame generation section 104-1 and the frame generation section 104-2. FIG. 5 is a diagram showing a format of a frame according to the present embodiment.

As shown in FIG. 4, the frame generation section 104 includes a FIFO 1003, an error correction encoder 1004, a header generation section 1005, and a multiplexer 1006. First, the frame generation section 104-1 is described. The FIFO 1003 acquires a video audio signal (information packet) that is inputted from the video audio generator 400 via an information packet input terminal 1001, and performs the speed adjustment of the video audio signal. Then, the FIFO 1003 outputs the video audio signal after speed adjustment to the error correction encoder 1004.

The error correction encoder 1004 performs error correction encoding on the basis of the video audio signal (information packet), and generates an error correction parity. For example, as shown in FIG. 5, the error correction encoder 1004 generates an error correction parity of 1 bytes on the basis of a video audio signal (information packet) of k bytes. Encoding of a Reed-Solomon (RS) code or the like is used for the error correction encoding by the error correction encoder 1004. The video audio signal (information packet) and the error correction parity are outputted to the multiplexer 1006.

In parallel with the video audio signal (information packet), the header generation section 1005 acquires a lane identifier that is inputted from the frame output section 107 via a lane identifier input terminal 1011. The lane identifier is an identifier of a transmission path through which a video audio frame generated by the frame generation section 104-1 is transmitted; in a case where lane switching described later has not been performed, the identifier of the transmission path 301-1 (e.g., “1”) is acquired by the frame generation section 104-1.

Further, the header generation section 1005 acquires information corresponding to the video audio signal that is inputted from the video audio generator 400 via an information type identifier input terminal 1002, as an information type identifier. The header generation section 1005 marks a frame start identifier on the front end of a frame to be transmitted, marks the lane identifier on a prescribed position of the frame to be transmitted, and marks the information type identifier on a prescribed position of the frame to be transmitted.

For example, as shown in FIG. 5, the header generation section 1005 sequentially incorporates the frame start identifier for identifying the start of the frame, and the acquired lane identifier and information type identifier into a header of m bytes, and outputs these identifiers to the multiplexer 1006. The relation of n=m+k+l holds among k, l, m, and n, which are the respective numbers of bytes shown in FIG. 5.

Any one of prescribed codes (hereinafter, occasionally referred to as “special data”) that do not exist in the video audio signal or the control signal is assigned to the frame start identifier. For example, the special data depend on the encoding of data transmitted and received through the transmission path. For example, in a case where ANSI 8b/10b conversion is used for the encoding of data transmitted and received through the transmission path, a K code may be assigned to a special code. For example, data in which a K code called K28.5 (0xBC) appears consecutively N bytes may be assigned to the frame start identifier.

The multiplexer 1006 sequentially outputs the header packet outputted from the header generation section 1005, and the video audio signal (information packet) and the error correction parity outputted from the error correction encoder 1004, and thereby generates a frame to be transmitted including the video audio signal (hereinafter, occasionally referred to as a “video audio frame”). The video audio frame generated by the multiplexer 1006 is outputted to the frame output section 107.

As described above, a video audio frame is generated from a video audio signal by the frame generation section 104-1 by a format having a prescribed data capacity (n bytes) as the frame unit. Further, the generation of a video audio frame is executed multiple times by the frame generation section 104-1, and thereby a plurality of video audio frames are generated from a video audio signal by a format having a prescribed data capacity (n bytes) as the frame unit.

Next, the frame generation section 104-2 is described. The FIFO 1003 acquires a control signal (information packet) that is inputted from the video audio generator 400 via the information packet input terminal 1001, and performs the speed adjustment of the control signal. Then, the FIFO 1003 outputs the control signal after speed adjustment to the error correction encoder 1004.

The error correction encoder 1004 performs encoding on the control signal (information packet), and generates an information packet and an error correction parity after encoding. For example, as shown in FIG. 5, the error correction encoder 1004 generates an error correction parity of 1 bytes for a control signal (information packet) of k bytes. Encoding of an RS code or the like is used for the encoding by the error correction encoder 1004. The control signal (information packet) and the error correction parity after encoding are outputted to the multiplexer 1006.

In parallel with the control signal (information packet), the header generation section 1005 acquires a lane identifier that is inputted from the frame output section 107 via the lane identifier input terminal 1011. The lane identifier is an identifier of a transmission path through which a control frame generated by the frame generation section 104-2 is transmitted; in a case where lane switching described later has not been performed, the identifier of the transmission path 301-2 (e.g., “2”) is acquired by the frame generation section 104-2.

Further, the header generation section 1005 acquires information corresponding to the control signal that is inputted from the video audio generator 400 via the information type identifier input terminal 1002, as an information type identifier. The header generation section 1005 marks a frame start identifier on the front end of a frame to be transmitted, marks the lane identifier on a prescribed position of the frame to be transmitted, and marks the information type identifier on a prescribed position of the frame to be transmitted.

For example, as shown in FIG. 5, the header generation section 1005 sequentially incorporates the frame start identifier for identifying the start of the frame, and the acquired lane identifier and information type identifier into a header of m bytes, and outputs these identifiers to the multiplexer 1006. The frame start identifier has similar properties to the frame start identifier that is incorporated into the header by the frame generation section 104-1.

The multiplexer 1006 sequentially outputs the header packet outputted from the header generation section 1005, and the control signal (information packet) and the error correction parity outputted from the error correction encoder 1004, and thereby generates a frame to be transmitted including the control signal (hereinafter, occasionally referred to as a “control frame”). The control frame generated by the multiplexer 1006 is outputted to the frame output section 107.

As described above, a control frame is generated from a control signal by the frame generation section 104-2 by a format having the same data capacity as the data capacity of the video audio frame (n bytes) as the frame unit. Further, the generation of a control frame is executed multiple times by the frame generation section 104-2, and thereby a plurality of control frames are generated from a control signal by a format having the same data capacity as the data capacity of the video audio frame (n bytes) as the frame unit.

The frame output section 107 outputs, to the LD 101-1 via an output terminal O-1, a video audio frame that is inputted from the frame generation section 104-1 via an input terminal I-1. On the other hand, the frame output section 107 outputs, to the LD 101-2 via an output terminal O-2, a control frame that is inputted from the frame generation section 104-2 via an input terminal I-2. Note that the frame output section 107 may perform encoding on the video audio frame and the control frame. Specifically, the frame output section 107 may perform 8b/10b encoding on the video audio frame and the control frame.

For example, the frame output section 107 may substitute the frame start identifier of each of the video audio frame and the control frame with corresponding special data of 10 bits, and may substitute data other than the frame start identifier with 10-bit data. Further, the frame output section 107 may convert the encoded video audio frame and the encoded control frame from parallel data to serial data in order to change these frames to a form suitable for high-speed transmission. The LDD 102-1 drives the LD 101-1, and the LDD 102-2 drives the LD 101-2.

The LD 101-1 (a first transmission section) transmits the video audio frame that is outputted from the frame output section 107 via the LDD 102-1, to the receiver 200 via the connectors CN1 and the transmission path 301-1 including an optical fiber. Note that, in the present embodiment, a case where the transmission path 301-1 includes an optical fiber and the video audio frame is transmitted to the receiver 200 after it is converted to an optical signal by the LD 101-1 is envisaged; but the type of the signal transmitted from the transmitter 100 to the receiver 200 is not limited. For example, the transmitter 100 may transmit the video audio frame to the receiver 200 by means of an electrical signal.

The LD 101-2 (a second transmission section) transmits the control frame that is outputted from the frame output section 107 via the LDD 102-2, to the receiver 200 via the connectors CN2 and the transmission path 301-2 including an optical fiber. Note that, in the present embodiment, a case where the transmission path 301-2 includes an optical fiber and the control frame is transmitted to the receiver 200 after it is converted to an optical signal by the LD 101-2 is envisaged; but the type of the signal transmitted from the transmitter 100 to the receiver 200 is not limited. For example, the transmitter 100 may transmit the control frame to the receiver 200 by means of an electrical signal.

The receiver 200 includes the PD 201-1 (a first reception section), the PD 201-2 (a second reception section), an amplifier 202-1, an amplifier 202-2, a signal extraction section 204-1 (a first signal extraction section), a signal extraction section 204-2 (a second signal extraction section), a signal output section 207, an error rate determination section 208, and a transmission section 209. The PD 201-1 receives a frame transmitted from the transmitter 100 (one of the video audio frame and the control frame). Further, the PD 201-2 receives a frame transmitted from the transmitter 100 by means of an optical signal (the other of the video audio frame and the control frame).

Note that, in the following, the frame received by the PD 201-1 may be referred to as a “first frame,” and the frame received by the PD 201-2 may be referred to as a “second frame.”

In the example shown in FIG. 3, the PD 201-1 is connected to the LD 101-1 via the connectors CN1 and the transmission path 301-1. Thus, the PD 201-1 receives, as the first frame, the video audio frame transmitted by the LD 101-1 via the connectors CN1 and the transmission path 301-1. On the other hand, the PD 201-2 is connected to the LD 101-2 via the connectors CN2 and the transmission path 301-2. Thus, the PD 201-2 receives, as the second frame, the control frame transmitted by the LD 101-2 via the connectors CN2 and the transmission path 301-2.

The PD 201-1 receives the light of the first frame that is transmitted by an optical signal from the transmitter 100, and converts the light to an electrical signal. Note that, although in the present embodiment a case where the transmission path 301-1 includes an optical fiber and the light of the frame is received and converted to an electrical signal by the PD 201-1 is envisaged, the type of the signal transmitted from the transmitter 100 to the receiver 200 is not limited, as mentioned above. For example, the receiver 200 may receive the first frame from the transmitter 100 by means of an electrical signal.

The PD 201-2 receives the light of the second frame that is transmitted by an optical signal from the transmitter 100 via the connectors CN2 and the transmission path 301-2, and converts the light to an electrical signal. Note that, although in the present embodiment a case where the transmission path 301-2 includes an optical fiber and the light of the frame is received and converted to an electrical signal by the PD 201-2 is envisaged, the type of the signal transmitted from the transmitter 100 to the receiver 200 is not limited, as mentioned above. For example, the receiver 200 may receive the second frame from the transmitter 100 by means of an electrical signal.

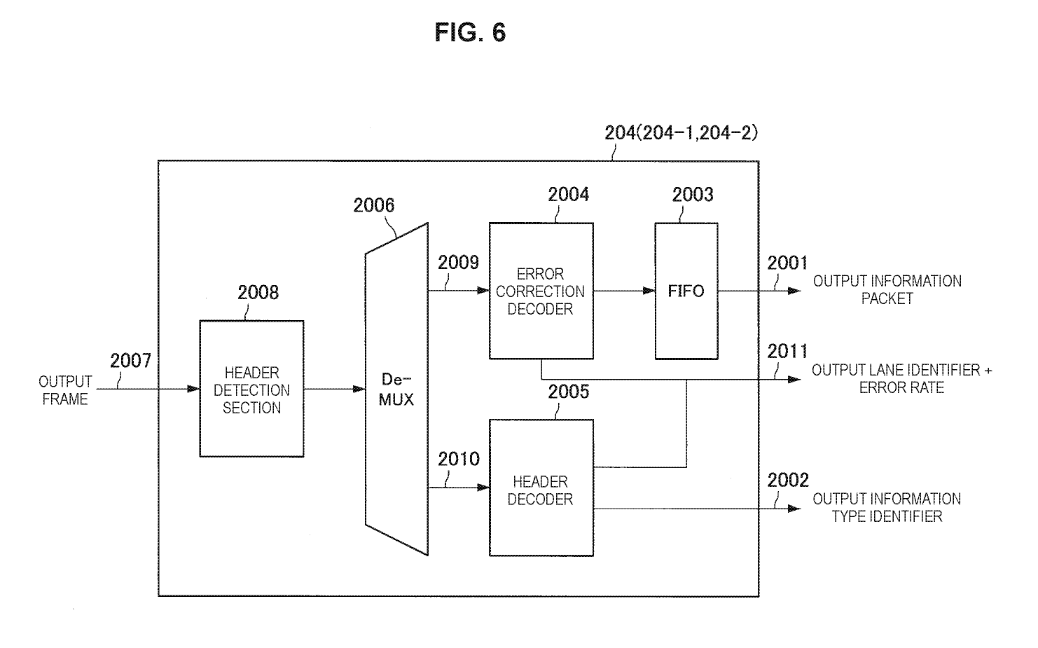

The amplifier 202-1 amplifies the first frame (an electrical signal) outputted from the PD 201-1, and outputs the amplified frame (an electrical signal) to the signal extraction section 204-1; and the amplifier 202-2 amplifies the second frame (an electrical signal) outputted from the PD 201-2, and outputs the amplified frame (an electrical signal) to the signal extraction section 204-2. For example, each of the amplifier 202-1 and the amplifier 202-2 may obtain a voltage signal by performing impedance conversion on a current signal, and may then perform amplitude amplification on the voltage signal. The first frame is inputted to the signal extraction section 204-1 from the PD 201-1 via the amplifier 202-1, and the second frame is inputted to the signal extraction section 204-2 from the PD 201-2 via the amplifier 202-1. FIG. 6 is a diagram showing an example of the functional configuration of a signal extraction section 204. Referring to FIG. 6, the example of the functional configuration of the signal extraction section 204 is shown without distinguishing the signal extraction section 204-1 and the signal extraction section 204-2. As shown in FIG. 6, the signal extraction section 204 includes a header detection section 2008, a demultiplexer 2006, an error correction decoder 2004, a header decoder 2005, and a FIFO 2003.

First, the signal extraction section 204-1 is described. Before the first frame inputted via a frame input terminal 2007 is inputted to the header detection section 2008, the signal extraction section 204-1 may convert the first frame from serial data to parallel data, and may decode the first frame converted to parallel data. Specifically, the signal extraction section 204-1 may perform 8b/10b decoding on the first frame. For example, the signal extraction section 204-1 may substitute, of the first frame, special data of 10 bits corresponding to the frame start identifier with the frame start identifier. On the other hand, the signal extraction section 204-1 may substitute also the remaining data of the first frame with 8-bit data.

The header detection section 2008 detects the header packet (see FIG. 5) from the inputted first frame. More specifically, since the frame start identifier substituted for the special code is marked on the front end of the first frame, the header detection section 2008 detects the frame start identifier and detects the position of the frame start identifier as the position of the front end of the first frame. The header detection section 2008 outputs the detected position of the frame start identifier and the first frame to the demultiplexer 2006.

On the basis of the position of the frame start identifier, the demultiplexer 2006 separates the header packet, the information packet, and the error correction parity from the first frame. More specifically, the demultiplexer 2006 extracts, as the header packet, data that span m bytes from the position of the frame start identifier, and outputs the data to the header decoder 2005.

On the other hand, the demultiplexer 2006 extracts, as a first signal (information packet) and the error correction parity, data that span (n-m) bytes from immediately after the header packet, and outputs the data to the error correction decoder 2004. Note that the first signal is one of the video audio signal and the control signal; in the example shown in FIG. 3, since the video audio frame is received as the first frame as mentioned above, the first signal extracted from the first frame is the video audio signal.

The error correction decoder 2004 extracts, as the first signal (information packet), data spanning the first k bytes out of the data spanning (n-m) bytes inputted from the demultiplexer 2006, and extracts data spanning the remaining 1 bytes as the error correction parity. The error correction decoder 2004 performs error correction decoding on the basis of the first signal (information packet) and the error correction parity; and the error-corrected information packet is outputted to the FIFO 2003, and the error rate is outputted to the error rate determination section 208 via an output terminal 2011.

The FIFO 2003 acquires the first signal (information packet) inputted from the error correction decoder 2004, and performs the speed adjustment of the first signal (information packet). Then, the FIFO 2003 outputs the first signal (information packet) after speed adjustment to the signal output section 207 via an output terminal 2001.

The header decoder 2005 extracts the lane identifier and the information type identifier from the inputted header packet. The header decoder 2005 outputs the extracted lane identifier to the error rate determination section 208 via the output terminal 2011. On the other hand, the header decoder 2005 outputs the extracted information type identifier to the signal output section 207 via an output terminal 2002.

Next, the signal extraction section 204-2 is described. Before the second frame inputted via the frame input terminal 2007 is inputted to the header detection section 2008, the signal extraction section 204-2 may convert the second frame from serial data to parallel data, and may decode the second frame converted to parallel data. Specifically, the signal extraction section 204-2 may perform 8b/10b decoding on the second frame. For example, the signal extraction section 204-2 may substitute, of the second frame, special data of 10 bits corresponding to the frame start identifier with the frame start identifier. On the other hand, the signal extraction section 204-2 may substitute also the remaining data of the second frame with 8-bit data.

The header detection section 2008 detects the header packet (see FIG. 5) from the inputted second frame. More specifically, since the frame start identifier substituted for the special code is marked on the front end of the second frame, the header detection section 2008 detects the frame start identifier and detects the position of the frame start identifier as the position of the front end of the second frame. The header detection section 2008 outputs the detected position of the frame start identifier and the second frame to the demultiplexer 2006.

On the basis of the position of the frame start identifier, the demultiplexer 2006 separates the header packet, the information packet, and the error correction parity from the second frame. More specifically, the demultiplexer 2006 extracts, as the header packet, data that span m bytes from the position of the frame start identifier, and outputs the data to the header decoder 2005.

On the other hand, the demultiplexer 2006 extracts, as a second signal (information packet) and the error correction parity, data that span (n-m) bytes from immediately after the header packet, and outputs the data to the error correction decoder 2004. Note that the first signal is the other of the video audio signal and the control signal; in the example shown in FIG. 3, since the control frame is received as the second frame as mentioned above, the second signal extracted from the second frame is the control signal.

The error correction decoder 2004 extracts, as the second signal (information packet), data spanning the first k bytes out of the data spanning (n-m) bytes inputted from the demultiplexer 2006, and extracts data spanning the remaining 1 bytes as the error correction parity. The error correction decoder 2004 performs error correction decoding on the basis of the second signal (information packet) and the error correction parity; and the error-corrected information packet is outputted to the FIFO 2003, and the error rate is outputted to the error rate determination section 208 via the output terminal 2011.

The FIFO 2003 acquires the second signal (information packet) inputted from the error correction decoder 2004, and performs the speed adjustment of the second signal (information packet). Then, the FIFO 2003 outputs the first signal (information packet) after speed adjustment to the signal output section 207 via the output terminal 2001.

The header decoder 2005 extracts the lane identifier and the information type identifier from the inputted header packet. The header decoder 2005 outputs the extracted lane identifier to the error rate determination section 208 via the output terminal 2011. On the other hand, the header decoder 2005 outputs the extracted information type identifier to the signal output section 207 via the output terminal 2002.

The signal output section 207 acquires the first signal via an input terminal I-1, and acquires the information type identifier of the first signal via an input terminal C-1. In a case where the information type identifier of the first signal is information corresponding to the video audio signal, the signal output section 207 outputs the first signal from an output terminal O-1 (a first output section). In the example shown in FIG. 3, as mentioned above, the video audio signal is extracted as the first signal, and the information type identifier is information corresponding to the video audio signal; thus, the first signal is outputted from the output terminal O-1 to the video audio reproducer 500.

Further, the signal output section 207 acquires the second signal via an input terminal I-2, and acquires the information type identifier of the second signal via an input terminal C-2. In a case where the information type identifier of the second signal is information corresponding to the control signal, the signal output section 207 outputs the second signal from an output terminal O-2 (a second output section). In the example shown in FIG. 3, as mentioned above, the control signal is extracted as the second signal, and the information type identifier is information corresponding to the control signal; thus, the second signal is outputted from the output terminal O-2 to the video audio reproducer 500.

The video audio reproducer 500 reproduces the inputted video audio signal (AV information 501) in accordance with the control signal (control information 502). The video audio reproducer 500 may be, for example, display devices such as a liquid crystal display (LCD), a plasma display panel (PDP), an organic electro-luminescence (EL) display, and a projector, a display device of holograms, audio output devices such as a loudspeaker and a headphone, and the like.

To the error rate determination section 208, the error rate of the first frame is inputted from the signal extraction section 204-1, and the error rate of the second frame is inputted from the signal extraction section 204-2. The error rate determination section 208 determines whether or not the error rate of the first frame and the error rate of the second frame satisfy a prescribed relationship. Herein, the first frame is the video audio frame and the second frame is the control frame; thus, the error rate determination section 208 determines whether or not the error rate of the second frame is lower than the error rate of the first frame.

The control signal is required to have higher reliability (a lower error rate) than the video audio signal; thus, in a case where the error rate of the second frame is lower than the error rate of the first frame, the transmission section 209 transmits that fact to the transmitter 100 via a cable 302. Herein, the error rate of the second frame is lower than the error rate of the first frame; thus, a case where that fact has been transmitted to the transmitter 100 is envisaged. Note that the type of the signal flowing through the cable 302 is not particularly limited either, and hence the signal flowing through the cable 302 may be an optical signal or may be an electrical signal.

In the transmitter 100, if the reception section 109 receives an output switching instruction from the receiver 200, the reception section 109 outputs the output switching instruction to the frame output section 107.

If the output switching instruction is inputted from the reception section 109, the frame output section 107 outputs a lane identifier change instruction to the frame generation section 104-1 via an output terminal LN, and performs switching so as to output a video audio frame that is inputted from the frame generation section 104-1 via the input terminal I-1, to the LD 101-2 via the output terminal O-2. If the output switching instruction is inputted from the frame output section 107, the frame generation section 104-1 sets an identifier of the transmission path 301-2 on the lane identifier marked on the video audio frame.

On the other hand, if the output switching instruction is inputted from the reception section 109, the frame output section 107 outputs a lane identifier change instruction to the frame generation section 104-2 via the output terminal LN, and performs switching so as to output a control frame that is inputted from the frame generation section 104-1 via the input terminal I-2, to the LD 101-1 via the output terminal O-1. If the output switching instruction is inputted from the frame output section 107, the frame generation section 104-2 sets an identifier of the transmission path 301-1 on the lane identifier marked on the control frame.

By such switching, lane switching is performed so that the video audio frame is transmitted via the transmission path 301-2 and the control frame is transmitted via the transmission path 301-1. Therefore, the possibility that the control signal, which is required to have higher reliability (a lower error rate) than the video audio signal, is transmitted correctly can be enhanced.

In the receiver 200, the control frame is received as the first frame by the PD 201-1, and the video audio frame is received as the second frame by the PD 201-2. In a case where the information type identifier of the first signal extracted by the signal extraction section 204-1 is information corresponding to the control signal, the signal output section 207 outputs the first signal from the output terminal O-2. Herein, the control signal is extracted as the first signal, and the information type identifier is information corresponding to the control signal; thus, the first signal is outputted from the output terminal O-2 to the video audio reproducer 500.

Further, in a case where the information type identifier of the second signal extracted by the signal extraction section 204-2 is information corresponding to the video audio signal, the signal output section 207 outputs the second signal from the output terminal O-1. Herein, the video audio signal is extracted as the second signal, and the information type identifier is information corresponding to the video audio signal; thus, the second signal is outputted from the output terminal O-1 to the video audio reproducer 500.

In this way, also in the receiver 200, output switching by the signal output section 207 is performed, and thereby the video audio signal and the control signal are outputted to the video audio reproducer 500 at desired positions.

### (2.2. Case Where Vertical Direction of Connector is Reverse)

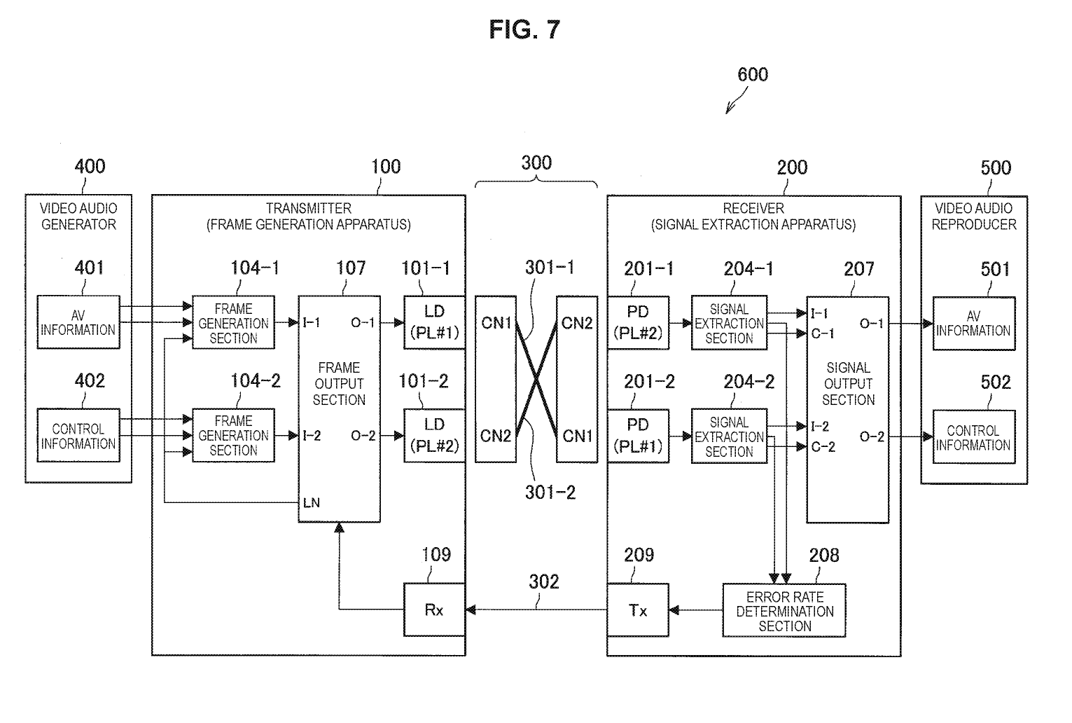

Next, a state where the vertical direction of the connector is the reverse is described. FIG. 7 is a diagram showing another example of the configuration of the image transmission system according to the present embodiment. In the example shown in FIG. 7, the LD 101-1 of the transmitter 100 and the connector CN1 of the cable 300 are connected together, and the PD 201-2 of the receiver 200 and the connector CN1 of the cable 300 are connected together. Further, the LD 101-2 of the transmitter 100 and the connector CN2 of the cable 300 are connected together, and the PD 201-1 of the receiver 200 and the connector CN2 of the cable 300 are connected together. Such a state is a state where the vertical direction of the connector is the reverse.

Even in the case where the vertical direction of the connector is the reverse, the transmitter 100 operates similarly to the case where the vertical direction of the connector is correct. Hence, a description of the operation of the transmitter 100 in the case where the vertical direction of the connector is the reverse is omitted. In the following, a description of, among the operations of the receiver 200 in the case where the vertical direction of the connector is the reverse, operations similar to operations of the receiver 200 in the case where the vertical direction of the connector is correct is omitted, and different operations are mainly described.

In the receiver 200, the PD 201-1 receives the first frame (one of the video audio frame and the control frame) transmitted from the transmitter 100. Further, the PD 201-2 receives the second frame (the other of the video audio frame and the control frame) transmitted from the transmitter 100 by means of an optical signal.

In the example shown in FIG. 7, the PD 201-1 is connected to the LD 101-2 via the connectors CN2 and the transmission path 301-2. Thus, the PD 201-1 receives, as the first frame, the control frame transmitted by the LD 101-2, via the connectors CN2 and the transmission path 301-2. On the other hand, the PD 201-2 is connected to the LD 101-1 via the connectors CN1 and the transmission path 301-1. Thus, the PD 201-2 receives, as the second frame, the video audio frame transmitted by the LD 101-1, via the connectors CN1 and the transmission path 301-1.

The first frame is inputted from the PD 201-1 to the signal extraction section 204-1 via the amplifier 202-1, and the second frame is inputted from the PD 201-2 to the signal extraction section 204-2 via the amplifier 202-2. First, the signal extraction section 204-1 is described.

The demultiplexer 2006 extracts data that span (n-m) bytes from immediately after the header packet, as the first signal (information packet) and the error correction parity, and outputs the data to the error correction decoder 2004. The first signal is one of the video audio signal and the control signal; in the example shown in FIG. 7, since the control frame is received as the first frame as mentioned above, the first signal extracted from the first frame is the control signal.

Next, the signal extraction section 204-2 is described. The demultiplexer 2006 extracts data that span (n-m) bytes from immediately after the header packet, as the second signal (information packet) and the error correction parity, and outputs the data to the error correction decoder 2004. The second signal is the other of the video audio signal and the control signal; in the example shown in FIG. 7, since the video audio frame is received as the second frame as mentioned above, the second signal extracted from the second frame is the video audio signal.

The signal output section 207 acquires the first signal via the input terminal I-1, and acquires the information type identifier of the first signal via the input terminal C-1. In a case where the information type identifier of the first signal is information corresponding to the control signal, the signal output section 207 outputs the first signal from the output terminal O-2 (the second output section). In the example shown in FIG. 7, as mentioned above, the control signal is extracted as the first signal, and the information type identifier is information corresponding to the control signal; thus, the first signal is outputted from the output terminal O-2 to the video audio reproducer 500.

Further, the signal output section 207 acquires the second signal via the input terminal I-2, and acquires the information type identifier of the second signal via the input terminal C-2. In a case where the information type identifier of the second signal is information corresponding to the video audio signal, the signal output section 207 outputs the second signal from the output terminal O-1 (the first output section). In the example shown in FIG. 7, as mentioned above, the video audio signal is extracted as the second signal, and the information type identifier is information corresponding to the video audio signal; thus, the second signal is outputted from the output terminal O-1 to the video audio reproducer 500.

The video audio reproducer 500 reproduces the inputted video audio signal (AV information 501) in accordance with the control signal (control information 502). By the function possessed by the receiver 200 described above, even in the case where the vertical direction of the connector is the reverse, the video audio reproducer 500 can reproduce the video audio signal in accordance with the control signal transmitted from the receiver 200 similarly to the case where the vertical direction of the connector is correct.

To the error rate determination section 208, the error rate of the second frame is inputted from the signal extraction section 204-1, and the error rate of the first frame is inputted from the signal extraction section 204-2. The error rate determination section 208 determines whether or not the error rate of the first frame and the error rate of the second frame satisfy a prescribed relationship. Herein, the first frame is the control frame and the second frame is the video audio frame; thus, it is determined whether or not the error rate of the first frame is lower than the error rate of the second frame.

The control signal is required to have higher reliability (a lower error rate) than the video audio signal; thus, in a case where the error rate of the first frame is lower than the error rate of the second frame, the transmission section 209 transmits that fact to the transmitter 100 via the cable 302. Herein, the error rate of the first frame is lower than the error rate of the second frame; thus, a case where that fact has been transmitted to the transmitter 100 is envisaged.

In the transmitter 100, if the reception section 109 receives an output switching instruction from the receiver 200, the reception section 109 outputs the output switching instruction to the frame output section 107.

If the output switching instruction is inputted from the reception section 109, the frame output section 107 outputs a lane identifier change instruction to the frame generation section 104-1 via the output terminal LN, and performs switching so as to output a video audio frame that is inputted from the frame generation section 104-1 via the input terminal I-1, to the LD 101-1 via the output terminal O-1. If the output switching instruction is inputted from the frame output section 107, the frame generation section 104-1 sets an identifier of the transmission path 301-1 on the lane identifier marked on the control frame.

On the other hand, if the output switching instruction is inputted from the reception section 109, the frame output section 107 outputs a lane identifier change instruction to the frame generation section 104-2 via the output terminal LN, and performs switching so as to output a control frame that is inputted from the frame generation section 104-2 via the input terminal I-2, to the LD 101-2 via the output terminal O-2. If the output switching instruction is inputted from the frame output section 107, the frame generation section 104-2 sets an identifier of the transmission path 301-2 on the lane identifier marked on the control frame.

By such switching, lane switching is performed so that the video audio frame is transmitted via the transmission path 301-1 and the control frame is transmitted via the transmission path 301-2. Therefore, the possibility that the control signal, which is required to have higher reliability (a lower error rate) than the video audio signal, is transmitted correctly can be enhanced.

In the receiver 200, the video audio frame is received as the first frame by the PD 201-1, and the control frame is received as the second frame by the PD 201-2. In a case where the information type identifier of the first signal extracted by the signal extraction section 204-1 is information corresponding to the video audio signal, the signal output section 207 outputs the first signal from the output terminal O-1. Herein, the video audio signal is extracted as the first signal, and the information type identifier is information corresponding to the video audio signal; thus, the first signal is outputted from the output terminal O-1 to the video audio reproducer 500.

Further, in a case where the information type identifier of the second signal extracted by the signal extraction section 204-2 is information corresponding to the control signal, the signal output section 207 outputs the second signal from the output terminal O-2. Herein, the control signal is extracted as the second signal, and the information type identifier is information corresponding to the control signal; thus, the second signal is outputted from the output terminal O-2 to the video audio reproducer 500.

In this way, also in the receiver 200, output switching by the signal output section 207 is performed, and thereby the video audio signal and the control signal are outputted to the video audio reproducer 500 at desired positions.

### <3. Conclusions>

As described hereinabove, according to an embodiment of the present disclosure, the frame generation apparatus 100 including the frame generation section 104-1 that generates one or more video audio frames from a video audio signal by a format having a prescribed data capacity as the frame unit and the frame generation section 104-2 that generates one or more control frames from a control signal by a format having the same data capacity as the prescribed data capacity as the frame unit is provided. By such a configuration, the format is standardized between the video audio frame and the control frame, and thereby the video audio signal and the control signal can be transmitted via connectors even if the vertical direction of the connector is reversed.

Further, according to an embodiment of the present disclosure, in a case where the error rate of the control frame is lower than the error rate of the video audio frame, the lane through which each of the video audio frame and the control frame is transmitted can be switched. By such a configuration, the possibility that the control signal, which is required to have higher reliability (a lower error rate) than the video audio signal, is transmitted correctly can be enhanced.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, each of the video audio generator 400, the frame generation section 104-1, the frame generation section 104-1, and the frame output section 107 may be mounted on a separate integrated circuit (IC), or a combination of any two or more of these may be mounted on the same IC. Further, for example, each of the signal extraction section 204-1, the signal extraction section 204-2, the signal output section 207, and the error rate determination section 208 may be mounted on a separate IC, or a combination of any two or more of these may be mounted on the same IC.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

A frame generation apparatus including:
a first frame generation section configured to generate one or more video audio frames from a video audio signal by a format having a prescribed data capacity as a frame unit; and
a second frame generation section configured to generate one or more control frames from a control signal by a format having the same data capacity as the prescribed data capacity as a frame unit.

(2)

The frame generation apparatus according to (1),
in which the first frame generation section marks a frame start identifier on a front end of each of the video audio frames, and
the second frame generation section marks the frame start identifier on a front end of each of the control frames.

(3)

The frame generation apparatus according to (2),
in which the frame start identifier is substituted with a prescribed code at least not existing in the video audio signal or the control signal.

(4)

The frame generation apparatus according to any one of (1) to (3),
in which the first frame generation section marks information for identifying a first transmission path as a lane identifier on a prescribed position of each of the video audio frames, and
the second frame generation section marks information for identifying a second transmission path as a lane identifier on a prescribed position of each of the control frames.

(5)

The frame generation apparatus according to (4), including:
a frame output section configured to output the video audio frame to a first transmission section connected to the first transmission path and output the control frame to a second transmission section connected to the second transmission path.

(6)

The frame generation apparatus according to (5),
in which, in a case where an error rate of the control frame is lower than an error rate of the video audio frame, the frame output section performs switching so as to output a new video audio frame to the second transmission section, and performs switching so as to output a new control frame to the first transmission section.

(7)

The frame generation apparatus according to any one of (1) to (6),
in which the first frame generation section marks information corresponding to the video audio signal as an information type identifier on a prescribed position of each of the video audio frames, and
the second frame generation section marks information corresponding to the control signal as an information type identifier on a prescribed position of each of the control frames.

(8)

A frame generation method including:
generating one or more video audio frames from a video audio signal by a format having a prescribed data capacity as a frame unit; and
generating one or more control frames from a control signal by a format having the same data capacity as the prescribed data capacity as a frame unit.

(9)

A signal extraction apparatus including:
a first signal extraction section configured to extract a first signal from one or more first frames having a prescribed data capacity as a frame unit; and
a second signal extraction section configured to extract a second signal from one or more second frames having the same data capacity as the prescribed data capacity as a frame unit,
in which, of a video audio signal and a control signal, one is the first signal and another is the second signal.

(10)

The signal extraction apparatus according to (9),
in which the first signal extraction section extracts the first signal on a basis of a position of a frame start identifier marked on a front end of the first frame, and
the second signal extraction section extracts the second signal on a basis of a position of the frame start identifier marked on a front end of the second frame.

(11)

The signal extraction apparatus according to (10),
in which the frame start identifier is substituted for a prescribed code at least not existing in the video audio signal or the control signal.

(12)

The signal extraction apparatus according to any one of (9) to (11),
in which the first signal extraction section extracts a lane identifier from each of the first frames, and
the second signal extraction section extracts a lane identifier from each of the second frames.

(13)

The signal extraction apparatus according to (12), including:
a signal output section configured to, in a case where the lane identifier extracted from the first frame is information for identifying a first transmission path, output the first signal from a first output section and output the second signal from a second output section.

(14)

The signal extraction apparatus according to (13),
in which, in a case where the lane identifier extracted from the first frame is information for identifying a second transmission path, the signal output section performs switching so as to output the first signal from the second output section and output the second signal from the first output section.

(15)

The signal extraction apparatus according to any one of (9) to (12),
in which the first signal extraction section extracts an information type identifier from each of the first frames, and
the second signal extraction section extracts an information type identifier from each of the second frames.

(16)

The signal extraction apparatus according to (15), including:
a signal output section configured to, in a case where the information type identifier extracted from the first frame is information corresponding to the video audio signal, output the first signal from a first output section and output the second signal from a second output section.

(17)

The signal extraction apparatus according to (16),
in which, in a case where the information type identifier extracted from the first frame is information corresponding to the control signal, the signal output section performs switching so as to output the first signal from the second output section and output the second signal from the first output section.

(18)

The signal extraction apparatus according to any one of (15) to (17), including:
an error rate determination section configured to determine whether or not an error rate of the second frame is lower than an error rate of the first frame.

(19)

A signal extraction method including:
extracting a first signal from one or more first frames having a prescribed data capacity as a frame unit; and
extracting a second signal from one or more second frames having the same data capacity as the prescribed data capacity as a frame unit,
in which, of a video audio signal and a control signal, one is the first signal and another is the second signal.

(20)

An image transmission system including:
a transmitter including
   a first frame generation section configured to generate one or more video audio frames from a video audio signal by a format having a prescribed data capacity as a frame unit,
   a second frame generation section configured to generate one or more control frames from a control signal by a format having the same data capacity as the prescribed data capacity as a frame unit,
   a first transmission section configured to transmit the video audio frame, and
   a second transmission section configured to transmit the control frame; and
a receiver including
   a first reception section configured to receive one or more first frames having the prescribed data capacity as a frame unit,
   a second reception section configured to receive one or more second frames having the same data capacity as the prescribed data capacity as a frame unit,
   a first signal extraction section configured to extract a first signal from the first frame, and
   a second signal extraction section configured to extract a second signal from the second frame,
   in which, of the video audio signal and the control signal, one is the first signal and another is the second signal.

### Reference Signs List

100 transmitter (frame generation apparatus)

104 frame generation section

1003 FIFO

1004 correction encoder

1005 header generation section

1006 multiplexer

107 frame output section

109 reception section

200 receiver

204 signal extraction section

2003 FIFO

2004 correction decoder

2005 header decoder

2006 demultiplexer

2008 header detection section

207 signal output section

208 error rate determination section

209 transmission section

300 cable

301 transmission path

400 video audio generator

401, 501 AV information (video audio signal)

402, 502 control information (control signal)

500 video audio reproducer

600 image transmission system

1. A frame generation apparatus comprising:
a first frame generation section configured to generate one or more video audio frames from a video audio signal by a format having a prescribed data capacity as a frame unit; and
a second frame generation section configured to generate one or more control frames from a control signal by a format having the same data capacity as the prescribed data capacity as a frame unit.

2. The frame generation apparatus according to claim 1,
wherein the first frame generation section marks a frame start identifier on a front end of each of the video audio frames, and
the second frame generation section marks the frame start identifier on a front end of each of the control frames.

3. The frame generation apparatus according to claim 2,
wherein the frame start identifier is substituted with a prescribed code at least not existing in the video audio signal or the control signal.

4. The frame generation apparatus according to claim 1,
wherein the first frame generation section marks information for identifying a first transmission path as a lane identifier on a prescribed position of each of the video audio frames, and
the second frame generation section marks information for identifying a second transmission path as a lane identifier on a prescribed position of each of the control frames.

5. The frame generation apparatus according to claim 4, comprising:
a frame output section configured to output the video audio frame to a first transmission section connected to the first transmission path and output the control frame to a second transmission section connected to the second transmission path.

6. The frame generation apparatus according to claim 5,
wherein, in a case where an error rate of the control frame is lower than an error rate of the video audio frame, the frame output section performs switching so as to output a new video audio frame to the second transmission section, and performs switching so as to output a new control frame to the first transmission section.

7. The frame generation apparatus according to claim 1,
wherein the first frame generation section marks information corresponding to the video audio signal as an information type identifier on a prescribed position of each of the video audio frames, and
the second frame generation section marks information corresponding to the control signal as an information type identifier on a prescribed position of each of the control frames.

8. A frame generation method comprising:
generating one or more video audio frames from a video audio signal by a format having a prescribed data capacity as a frame unit; and
generating one or more control frames from a control signal by a format having the same data capacity as the prescribed data capacity as a frame unit.

9. A signal extraction apparatus comprising:
a first signal extraction section configured to extract a first signal from one or more first frames having a prescribed data capacity as a frame unit; and
a second signal extraction section configured to extract a second signal from one or more second frames having the same data capacity as the prescribed data capacity as a frame unit,
wherein, of a video audio signal and a control signal, one is the first signal and another is the second signal.

10. The signal extraction apparatus according to claim 9,
wherein the first signal extraction section extracts the first signal on a basis of a position of a frame start identifier marked on a front end of the first frame, and
the second signal extraction section extracts the second signal on a basis of a position of the frame start identifier marked on a front end of the second frame.

11. The signal extraction apparatus according to claim 10,
wherein the frame start identifier is substituted for a prescribed code at least not existing in the video audio signal or the control signal.

12. The signal extraction apparatus according to claim 9,
wherein the first signal extraction section extracts a lane identifier from each of the first frames, and
the second signal extraction section extracts a lane identifier from each of the second frames.

13. The signal extraction apparatus according to claim 12, comprising:
a signal output section configured to, in a case where the lane identifier extracted from the first frame is information for identifying a first transmission path, output the first signal from a first output section and output the second signal from a second output section.

14. The signal extraction apparatus according to claim 13,
wherein, in a case where the lane identifier extracted from the first frame is information for identifying a second transmission path, the signal output section performs switching so as to output the first signal from the second output section and output the second signal from the first output section.

15. The signal extraction apparatus according to claim 9,
wherein the first signal extraction section extracts an information type identifier from each of the first frames, and
the second signal extraction section extracts an information type identifier from each of the second frames.

16. The signal extraction apparatus according to claim 15, comprising:
a signal output section configured to, in a case where the information type identifier extracted from the first frame is information corresponding to the video audio signal, output the first signal from a first output section and output the second signal from a second output section.

17. The signal extraction apparatus according to claim 16,
wherein, in a case where the information type identifier extracted from the first frame is information corresponding to the control signal, the signal output section performs switching so as to output the first signal from the second output section and output the second signal from the first output section.

18. The signal extraction apparatus according to claim 15, comprising:
an error rate determination section configured to determine whether or not an error rate of the second frame is lower than an error rate of the first frame.

19. A signal extraction method comprising:
extracting a first signal from one or more first frames having a prescribed data capacity as a frame unit; and
extracting a second signal from one or more second frames having the same data capacity as the prescribed data capacity as a frame unit,
wherein, of a video audio signal and a control signal, one is the first signal and another is the second signal.

20. An image transmission system comprising:
a transmitter including
a first frame generation section configured to generate one or more video audio frames from a video audio signal by a format having a prescribed data capacity as a frame unit,
a second frame generation section configured to generate one or more control frames from a control signal by a format having the same data capacity as the prescribed data capacity as a frame unit,
a first transmission section configured to transmit the video audio frame, and
a second transmission section configured to transmit the control frame; and
a receiver including
a first reception section configured to receive one or more first frames having the prescribed data capacity as a frame unit,
a second reception section configured to receive one or more second frames having the same data capacity as the prescribed data capacity as a frame unit,
a first signal extraction section configured to extract a first signal from the first frame, and
a second signal extraction section configured to extract a second signal from the second frame,
wherein, of the video audio signal and the control signal, one is the first signal and another is the second signal.
